(19) United States
(12) Patent Application Publication
(10) Pub. No.: US 2006/0178262 A1
(43) Pub. Date: Aug. 10, 2006

(54) Hydrogenation catalyst

(76) Inventors: Andrzej Rokicki, Mountain Lakes, NJ (US); Morlyasu Sugeta, Toyama City (JP); David Linke, Berlin (DE); Steven A. Blankenship, Radcliff, KY (US); Jennifer Boyer, Prospect, KY (US)

Correspondence Address: SUD-CHEMIE INC., 1600 WEST HILL STREET, LOUISVILLE, KY, 40210, US

(21) Appl. No.: 11/334,824

(22) Filed: Jan. 19, 2006

Related U.S. Application Data
(60) Provisional application No. 60/645,431, filed on Jan. 20, 2005.

(51) Int. Cl. B01J 23/56

(52) U.S. Cl. 502/330; 502/339

(57) ABSTRACT

The present development relates to a catalyst composition for the selective hydrogenation of acetylene and to a method for preparing the catalyst. The catalyst comprises iridium, palladium and, optionally, at least one of the elements selected from the group consisting of silver, gold, copper, zinc and tin. In a preferred embodiment, the catalyst is prepared such that the palladium is located within the first 250 micrometers of the surface of the catalyst carrier. In contrast to the catalysts of the prior art, including for example, palladium/silver catalysts, the catalyst of the present invention exhibits high selectivity and an improved stability of the catalytic performance over an extended period of time.

### CROSS REFERENCE TO RELATED APPLICATIONS

This application claims priority to U.S. Provisional Patent Application 60/645,431 filed on Jan. 20, 2005, which is incorporated herein in its entirety by reference.

### BACKGROUND

The present development relates to a catalyst composition for hydrogenation processes and to a method for preparing the catalyst. The catalyst comprises iridium, palladium and, optionally, at least one of the elements selected from the group consisting of silver, gold, copper, zinc and tin. As reported herein, the catalyst may be used for hydrogenation reactions such as the selective hydrogenation of acetylene.

Processes producing unsaturated hydrocarbons usually involve cracking of various types of hydrocarbons and often produce a crude product containing hydrocarbon impurities that are more unsaturated than the desired product. These unsaturated hydrocarbon impurities are often difficult to separate from the desired product. For example, it is desirable that polymer grade ethylene has an acetylene content of less than about five (5) parts per million by weight. However, it can be difficult to separate the ethylene from the acetylene when the acetylene content is greater than five parts per million.

One technique that has been used for reducing the amount of acetylene in ethylene is to selectively hydrogenate the acetylene using a catalyst comprising palladium supported on a carrier like alumina. In the hydrogenation process, it is highly desirable to remove the undesired highly unsaturated acetylene without hydrogenating the desired ethylene to ethane. However, it has been difficult to develop a catalyst that can perform this selective hydrogenation process for an extended period. For example, palladium on gamma-alumina catalysts have been reported as effective selective hydrogenation catalysts, but the selectivity has diminished rapidly in less than 100 hours on stream. (See, for example, GB Patent 916,056; J. Mol. Catal. A 173 (2001) 185-221; Catal. Today 24 (1997) 181-197; J. Catal. 158 (1996) 227-278; Appl. Catal. 10 (1984)369.)

Because presently known supported Pd-containing catalysts deactivate with time on stream, there exists a need to develop catalysts and processes for hydrogenating acetylene, which offer improved stability of the performance over time. What is especially important is that the selectivity to ethylene remains high and that the selectivity to the undesired ethane stays lower than presently achievable with state-of-the art catalysts.

Accordingly, it is an object of the present invention to disclose a catalyst composition for use in a process for the selective hydrogenation of acetylene, wherein the catalyst remains selective for the hydrogenation of acetylene, and does not promote the hydrogenation of ethylene, more effectively than observed with prior art catalysts.

### SUMMARY OF THE INVENTION

The present development relates to a catalyst composition for the selective hydrogenation of acetylene and to a method for preparing the catalyst. In contrast to the catalysts of the prior art, including for example, palladium/silver catalysts, the catalyst of the present invention exhibits high selectivity and an improved stability of the catalytic performance over an extended period of time.

The catalyst comprises from about 0.001 wt% to about 1.5 wt%, iridium, from about 0.005 wt% to about 0.5 wt% palladium and, optionally, at least one of the elements selected from the group consisting of silver, gold, copper, zinc and tin, at a concentration of up to about 0.5 wt%. In a preferred embodiment, the catalyst is prepared such that the palladium is located within the first 250 micrometers of the surface of the catalyst carrier.

### DETAILED DESCRIPTION OF THE PREFERRED EMBODIMENT

The present invention is a catalyst for the selective hydrogenation of acetylene for ethylene purification. The invention further comprises a process for the production of the catalyst that is useful for the selective hydrogenation of acetylene for ethylene purification and a process of hydrogenation of the acetylene for ethylene purification using the catalyst of the invention.

The catalyst of the invention is primarily designed for the selective hydrogenation of acetylene in an ethylene stream. Ethylene feed streams typically contain impurities such as hydrogen, methane, ethane, carbon monoxide and acetylene. The goal of the selective hydrogenation is to reduce the amount of the acetylene impurity present in the feed without substantially reducing the amount of ethylene that is present in the feed.

As is known in the art, catalysts are used in the selective hydrogenation of acetylene process. However, deactivation of the catalyst may occur. This deactivation manifests itself as a decreasing selectivity to the desired ethylene and an increasing selectivity to the undesired ethane. Moreover, deactivation can reduce the activity of the catalyst used in the process.

The catalyst of the present invention comprises iridium (“Ir”) and palladium (“Pd”) and, optionally, a promoter (“M”), on an inorganic carrier. The catalyst carrier may be any carrier generally known in the art for use in hydrogenation catalysts. For example, the carrier may be metal aluminates, such as calcium aluminate, magnesium aluminate, barium hexaluminate, nickel aluminate, and alumina, silica, silica-alumina, activated carbon, ceria, zirconia, chromia-alumina, titania, magnesium oxide, and mixtures thereof. In an exemplary embodiment, without limitation, the carrier is an alumina having a surface area of from about 30 m²/g to about 50 m²/g. In an alternative embodiment, the carrier is an alpha-alumina.

The catalyst of the present invention has the general stoichiometric formula IrₓPd_{y}M_{z}, wherein the iridium concentration is from about 0.001 wt% to about 1.5 wt% and the palladium concentration is from about 0.005 wt% to about 0.5 wt% and the promoter concentration is up to about 0.5 wt%. In an exemplary embodiment, without limitation, the catalyst comprises iridium at a concentration of from about 0.01 wt% to about 0.06 wt% and palladium at a concentration of from about 0.01 wt% to about 0.06 wt% and the promoter at a concentration of up to about 0.2 wt%. Palladium catalysts are generally known in the art as effective hydrogenation catalysts. However, iridium appears to be a key component for achieving long-term stability and for suppressing deactivation. As is further known in the art, a promoter (“M”) may be added to a catalyst to reduce deactivation and to reduce green-oil formation. In the present development, the promoter is selected from the group consisting of silver, gold, copper, zinc, tin and combinations thereof.

The catalyst may be prepared by any procedure known in the art. In an exemplary embodiment, aqueous solutions of metal chlorides are used as precursors for all metals, except for Ag for which AgNO₃ can be used, and the metals are deposited by either excess solution impregnation or incipient wetness impregnation techniques. The catalysts are then dried and calcined. In a preferred embodiment, the catalyst is prepared such that the palladium is located within the first 250 micrometers of the surface of the catalyst carrier. Such methods are taught in U.S. Pat. Nos. 4,484,015 and 4,404,124, both of which are incorporated in their entirety by reference.

The catalyst is intended for use in hydrogenation reactions, and may further be useful in oxidation reactions. For example, the catalyst may be useful for the hydrogenation of acetylenes, including substituted acetylenes such as, without limitation, methyl acetylenes or methyl acetylenes/propadienes (MAPD). Alternatively, the catalyst may be used for oxidation reactions, such as, without limitation, the oxidation of vinyl acetate.

The catalyst of the present invention differs from catalysts of the prior art by including iridium with palladium and a promoter, thereby producing a more stable catalyst than catalysts of the prior art. It is understood that the catalyst of the present invention may be prepared by other methods than disclosed herein and may be supported on carriers other than those specified herein without exceeding the scope of this development.

What is claimed is:

1. A catalyst for the selective hydrogenation of acetylene comprising iridium (“Ir”) and palladium (“Pd”) and a promoter (“M”) on an inorganic carrier, wherein said promoter is selected from the group consisting of silver, gold, copper, zinc, tin and combinations thereof, and wherein said inorganic carrier is selected from the group consisting of alumina, silica, silica-alumina, activated carbon, ceria, zirconia, chromia-alumina, titania, magnesium oxide, metal aluminates, calcium aluminate, magnesium aluminate, barium hexaluminate, nickel aluminate and mixtures thereof.

2. The catalyst of claim 1 wherein said iridium is present at a concentration of from about 0.001 wt% to about 1.5 wt%.

3. The catalyst of claim 2 wherein said iridium is present at a concentration of from about 0.01 wt% to about 0.06 wt%.

4. The catalyst of claim 1 wherein said palladium is present at a concentration of from about 0.005 wt% to about 0.5 wt%.

5. The catalyst of claim 4 wherein said palladium is present at a concentration of 0.01 wt% to about 0.06 wt%.

6. The catalyst of claim 1 wherein said promoter is present at a concentration of up to about 0.5 wt%.

7. The catalyst of claim 6 wherein said promoter is present at a concentration of up to about 0.2 wt%.

8. The catalyst of claim 1 wherein said carrier is an alumina having a surface area of from about 30 m²/g to about 50 m²/g.

9. The catalyst of claim 1 wherein said carrier is alpha-alumina.

10. A catalyst for the selective hydrogenation of acetylene comprising an inorganic carrier and from about 0.001 wt% to about 1.5 wt% iridium (“Ir”) and from about 0.005 wt% to about 0.5 wt% palladium (“Pd”) and up to about 0.5 wt% of a promoter (“M”), wherein said promoter is selected from the group consisting of silver, gold, copper, zinc, tin and combinations thereof.

11. The catalyst of claim 10 wherein said carrier is selected from the group consisting of alumina, silica, silica-alumina, activated carbon, ceria, zirconia, chromia-alumina, titania, magnesium oxide, metal aluminates, calcium aluminate, magnesium aluminate, barium hexaluminate, nickel aluminate and mixtures thereof.

12. The catalyst of claim 11 wherein said carrier is an alumina having a surface area of from about 30 m²/g to about 50 m²/g.

13. The catalyst of claim 11 wherein said carrier is alpha-alumina.

14. The catalyst of claim 10 wherein said iridium, said palladium and said promoters are deposited by excess solution impregnation techniques.

15. The catalyst of claim 10 wherein said iridium, said palladium and said promoters are deposited by incipient wetness impregnation techniques.

16. The catalyst claim 10 wherein said iridium is present at a concentration of from about 0.01 wt% to about 0.06 wt%, and said palladium is present at a concentration of 0.01 wt% to about 0.06 wt%.

17. A catalyst for the selective hydrogenation of acetylene comprising iridium (“Ir”) and palladium (“Pd”) on an inorganic carrier, and wherein said palladium is located within the first 250 micrometers of the surface of the catalyst carrier.

18. The catalyst of claim 17 wherein said catalyst comprises said iridium at a concentration of from about 0.001 wt% to about 1.5 wt%, and said catalyst comprises said palladium at a concentration of from about 0.005 wt% to about 0.5 wt%.

19. The catalyst of claim 17 further comprising up to about 0.5 wt% of a promoter (“M”) selected from the group consisting of silver, gold, copper, zinc, tin and combinations thereof.

20. The catalyst of claim 19 wherein said catalyst comprises said iridium at a concentration of from about 0.01 wt% to about 0.06 wt%, and said catalyst comprises said palladium at a concentration of from about 0.01 wt% to about 0.06 wt%, and said catalyst comprises said promoter at a concentration of up to about 0.2 wt%.

21. The catalyst of claim 17 wherein said carrier is selected from the group consisting of alumina, silica, silica-alumina, activated carbon, ceria, zirconia, chromia-alumina, titania, magnesium oxide, metal aluminates, calcium aluminate, magnesium aluminate, barium hexaluminate, nickel aluminate and mixtures thereof.
